(19) United States
(12) Patent Application Publication
(10) Pub. No.: US 2012/0261361 A1
(43) Pub. Date: Oct. 18, 2012

(54) Multi Turkey Fan Mount

(76) Inventor: Timothy J. DELAND, Minocqua, WI (US)

(21) Appl. No.: 13/447,027

(22) Filed: Apr. 13, 2012

Related U.S. Application Data
(60) Provisional application No. 61/476,081, filed on Apr. 15, 2011.

(51) Int. Cl. A47F 7/00; B23P 11/00

(52) U.S. Cl. 211/13.1; 29/525.02; 29/469

(57) ABSTRACT

The present invention is a multi turkey fan mount utilized to display a plurality of turkey fans in a diagonal series from a wall. The multi turkey fan mount comprises a wall plate, a dadoed fan bracket, a plurality of dadoes, a plurality of dividers, a plurality of spaces, a plurality of foam blocks, and a face plaque. During use, each of the plurality of turkey fans is affixed within each of the plurality of spaces located between the plurality of dadoes and the plurality of dividers. Each of the plurality of foam blocks is used to affix each of the plurality of turkey fans in place. Located at the front end of the present invention is the face plaque. The face plaque comprises a graphic on its front side and a fastener on its back side. The fastener allows the face plaque to attach to the present invention.

The current application claims a priority to the U.S. Provisional Patent application Ser. No. 61/476,081 filed on Apr. 15, 2011.

### FIELD OF THE INVENTION

The present invention relates generally to a trophy mount for displaying turkey fan tails in a decorative manner upon a wall.

### BACKGROUND OF THE INVENTION

One of the fastest growing areas of hunting activity is currently that of taking wild turkeys, which is regarded by experienced hunters as being one of the more challenging wild game species to hunt. As it is the antler size of a horned animal that is indicative of the strength and virility of the male of any particular species, it is the spread of the tail fan of the male turkey that is indicative of his strength and virility. Therefore, a large turkey tail fan is regarded as a trophy amongst hunters and turkeys alike. Most hunters would like to preserve and mount fully body turkeys on display, but such preservation in the form of full body mounts is not only very costly but also not practical since space occupied by a single turkey trophy may be large. Thus, it is a desirable and acceptable alternative to mount and display a series of decorative turkey fans accompanied by an ornamental face plaque. The present invention provides an inexpensive mount for displaying a series of turkey fans. Additionally, the present invention provides a method of constructing the said inexpensive mount.

### BRIEF DESCRIPTION OF THE DRAWINGS

FIG. 1 is a front view of the present invention.

FIG. 2 is a left perspective view of the present invention.

FIG. 3 is a back perspective view of the present invention.

FIG. 4 is a left side view of the present invention.

FIG. 5 is a right side view of the present invention.

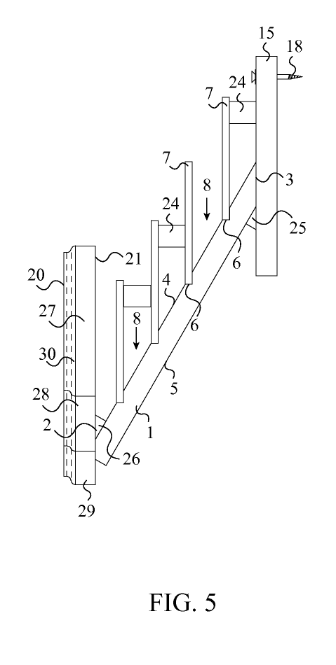

FIG. 6 is a perspective view of the present invention without the face plaque.

FIG. 7 is a front view of the face plaque.

FIG. 8 is a back view of the face plaque.

FIG. 9 is a front functional view of the present invention.

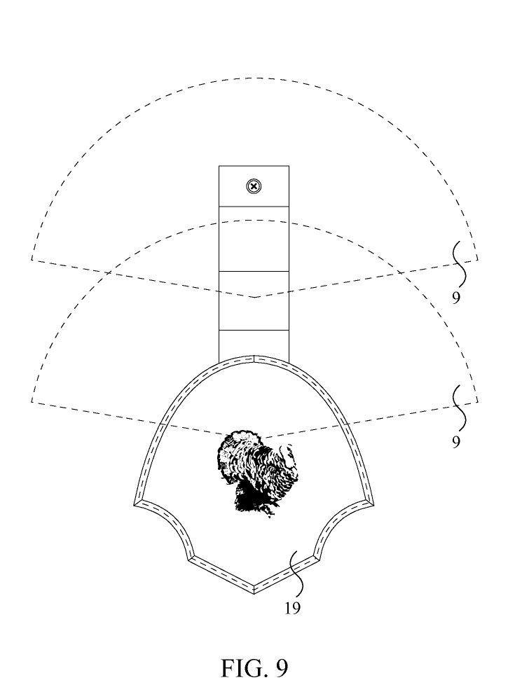

FIG. 10 is a perspective functional view of the present invention.

### DETAILED DESCRIPTION OF THE INVENTION

All illustrations of the drawings are for the purpose of describing selected versions of the present invention and are not intended to limit the scope of the present invention.

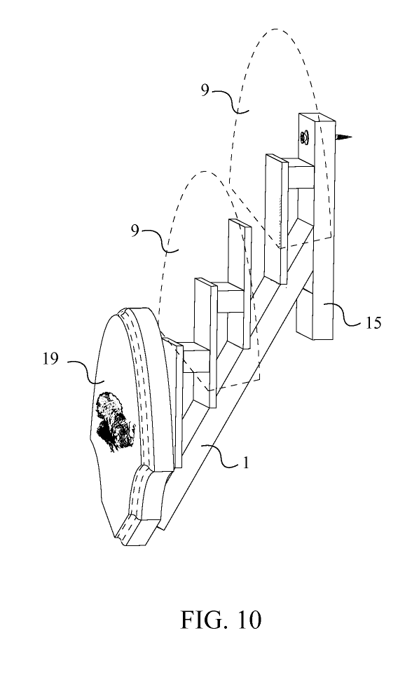

The present invention is a multi turkey fan mount used to decoratively display a plurality of turkey fans 9 in a diagonal series from a wall or a flat surface at a predetermined downward angle. The present invention also comprises the method of constructing the multi turkey fan mount, which is specified hereinafter. The multi turkey fan mount is recognizable with a dadoed fan bracket 1, a plurality of dividers 7, a wall plate 15 and a face plaque 19 as shown in FIG. 10.

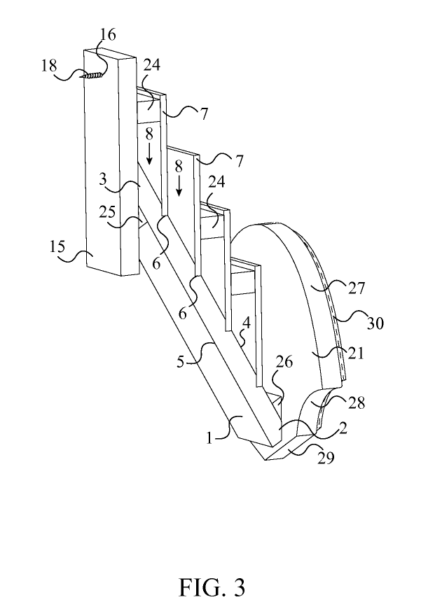

Along the dadoed fan bracket 1 is a plurality of dadoes 6, which can be can seen in FIG. 3. Each of the plurality of the dadoes 6 is a three-sided rectangular channel expanding horizontally from one edge of the dadoed fan bracket 1 to another edge of the dadoed fan bracket 1. Furthermore, each of the plurality of the dadoes 6 is evenly spaced from each other and tilted at an angle along a top bracket side 4 of the dadoed fan bracket 1. Therefore, the plurality of dadoes 6 is evenly and serially distributed along the vertical length of the dadoed fan bracket 1. Moreover, the plurality of dadoes 6 is positioned equidistant from each other along the vertical length of the dadoed fan bracket 1. In the preferred embodiment, the plurality of dadoes 6 have been cut into the dadoed fan bracket 1 in a manner wherein each of the plurality of the dadoes is a 90 degree, L-shaped cut along the tilted vertical length of the dadoed fan bracket 1. Specifically, the bottom of each of the plurality of dadoes 6 is parallel to the horizontal width of the wall plate 15, and the side of each of the plurality of dadoes 6 is parallel to the vertical length of the wall plate 15. Thus, along the tiled vertical length of the dadoed fan bracket 1, the plurality of dadoes 6 is positioned in a descending manner wherein each consecutive dado of the plurality of dadoes 6 is positioned lower than the previous one, from a back bracket side 3 of the dadoed fan bracket 1 to a front bracket side 2 of the dadoed fan bracket 1. The plurality of dadoes 6 serve as insertion grooves for the affixation of a plurality of dividers 7.

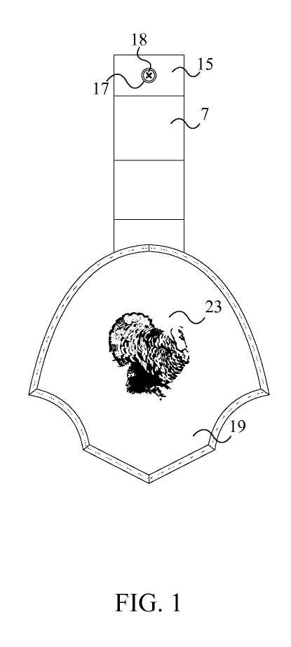

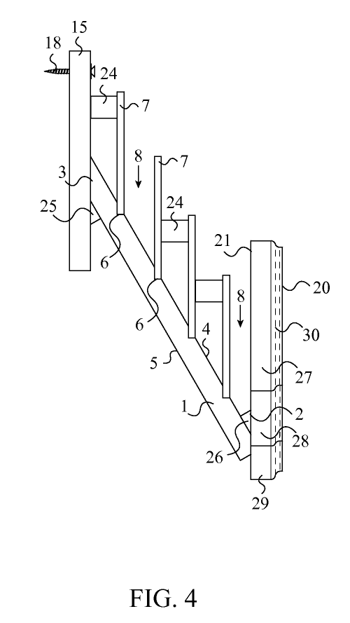

Similar to the plurality of dadoes 6, the plurality of dividers 7 is evenly and serially distributed along the tilted vertical length of the dadoed fan bracket 1. Each of the plurality of dividers 7 is dimensioned to be identical to each other. Moreover, the plurality of dividers 7 is positioned equidistant from each other on the top bracket side 4 of the dadoed fan bracket 1. In the preferred embodiment, the plurality of dividers 7 is rectangular birch plywood blocks with ⅜ of an inch thickness. The thickness of each of the plurality of dividers 7 is aligned and affixed within each of the plurality of dadoes 6 as can be seen in FIG. 4. Furthermore, the lateral sides of the plurality of dividers 7 are positioned in a leveled manner with the lateral sides of the dadoed fan bracket 1. Since each of the plurality of dividers 7 is positioned within each of the plurality of dadoes 6, the plurality of dividers 7 is also evenly and serially distributed along the tilted vertical length of the dadoed fan bracket 1 after insertion and affixation. Since the dadoed fan bracket 1 is positioned at a calculated angle, the plurality of dividers 7 is also situated on the top bracket side 4 of the dadoed fan bracket 1 at the same angle. Therefore, each consecutive divider of the plurality of dividers 7 is situated on the dadoed fan bracket 1 in a descending manner wherein each divider is positioned lower than the previous one along the tilted vertical length of the dadoed fan bracket 1, from the back bracket side 3 of the dadoed fan bracket 1 to the front bracket side 2 of the dadoed fan bracket 1. Furthermore, the present invention resembles a miniature staircase if viewed in the front view as in FIG. 1. Since each of the plurality of dividers 7 is evenly spaced from each other, there is a plurality of spaces 8 between each of the plurality of dividers 7.

Similar to the plurality of dadoes 6 and the plurality of dividers 7, the plurality of spaces 8 is also evenly and serially distributed along the tilted vertical length of the dadoed fan bracket 1 as can be seen in FIG. 4. Due to the equidistant position of each of plurality of dividers from each other, the plurality of spaces 8 is also equidistant from each other. The plurality of spaces 8 allows the plurality of turkey fans 9 or similar decorations to go in between the plurality of dividers 7. Each of the plurality of turkey fans 9 is then positioned and adhered in place by an insertion of each of a plurality of foam blocks 24 into each of the plurality of spaces 8. Each of the plurality of foam blocks 24 serves as a wedge to keep each of the plurality of turkey fans 9 secured in place, in each of the plurality of spaces 8. In the preferred embodiment, the present invention supports four turkey fans. Each of the plurality of foam blocks 24 comprises a 1×1 inch cross section. The length of each of the plurality of foam blocks 24 is 2⅞ inches.

During use, each of the plurality of turkey fans 9 is inserted into each of the plurality of spaces 8 wherein each of the plurality of foam blocks 24 is situated behind each of the plurality of turkey fans 9 and within each of the plurality of spaces 8, which can be seen in FIG. 10. In the preferred arrangement of the plurality of turkey fans 9, not all of the plurality of spaces 8 is occupied by the plurality of foam blocks 24. Each of the plurality of foam blocks 24 is inserted in the plurality of spaces 8 in a manner wherein a foam block occupies every other space of the plurality of spaces 8.

As can be seen in FIG. 3, the wall plate 15 of the present invention serves as a base to support the entirety of the present invention. The wall plate 15 also serves as an attachment platform to adhere the present invention upon a wall or a flat surface. Therefore, the wall plate 15 comprises a wall plate screw hole 16, a wall plate screw 18, and a washer 17. The washer 17 is positioned concentrically around the wall plate screw hole 16 with the wall plate screw 18 collinearly traversing through the washer 17 and the wall plate screw hole 16. The wall plate screw hole 16, the wall plate screw 18 and the washer 17 serve as an attachment point for the wall plate 15 to be attached to the wall. In the preferred embodiment, a 2-inch wood screw is applied to the wall plate screw hole 16. The wall plate 15 is adhered to the back bracket side 3 of the dadoed fan bracket 1 and an angled support block 25. Both of the back bracket side 3 of the dadoed fan bracket 1 and the angled support block 25 have been cut at an angle and adhered to the flat surface of the wall plate 15 wherein the back bracket side 3 of the dadoed fan bracket 1 and the angled support block 25 are positioned adjacent to each other in a leveled manner against the flat surface of the wall plate 15. In the preferred embodiment, the angle is 60 degrees. The angle gives the dadoed fan bracket 1 a tilted protrusion from the wall plate 15. Specifically, the tilted protrusion is 10⅞ inches from the wall if measured perpendicularly from the wall.

As can be seen in FIG. 3, the angled support block 25 serves to counter the weight of the dadoed fan bracket 1. Therefore, the angled support block 25 is positioned and adhered to a bottom bracket side 5 of the dadoed fan bracket 1. Moreover, the angled support block 25 gives additional area of adhesion between the dadoed fan bracket 1 and the wall plate 15. A large area of adhesion between the dadoed fan bracket 1 and the wall plate 15 allows for better adhesion and overall stability. Therefore, the angled support block 25 gives an increased area of adhesion to the back bracket side 3 of the dadoed fan bracket 1. Similarly, a hanger hardware block 26 adhered to the top bracket side 4 of the dadoed fan bracket 1 and a front bracket side 2 of the dadoed fan bracket 1 serves a similar function as the angled support block 25. The hanger hardware block 26 is adhered flush and adjacent to the front end of the dadoed fan bracket 1. Therefore, both of the hanger hardware block 26 and the front end of the dadoed fan bracket 1 form the front bracket side 2 of the dadoed fan bracket 1. The hanger hardware block 26 provides the present invention an increased area of attachment between the front bracket side 2 and the face plaque 19. Furthermore, the hanger hardware block 26 provides an increased area of attachment for a first fastener 10 to be attached to both the hanger hardware block 26 and the front end of the dadoed fan bracket 1 namely the front bracket side 2 of the dadoed fan bracket 1.

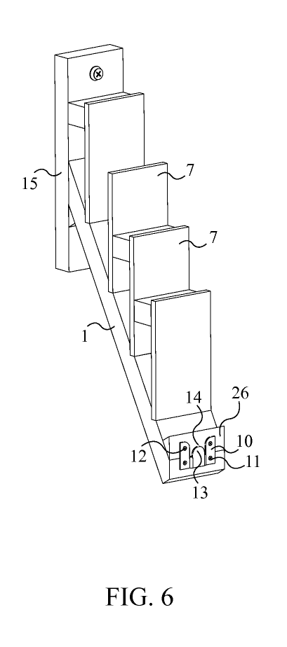

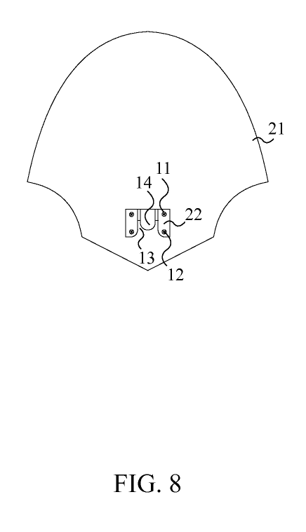

Attached centered to the front bracket side 2 is a first fastener 10, which is illustrated in FIG. 6. Similarly, attached centered to a back plaque side 21 of the face plaque 19 is a second fastener 22, which can be seen in FIG. 8. The first fastener 10 and the second fastener 22 each comprises a plurality of fastener screw holes 11, a plurality of fastener screws 12, a slot 13 and a flange 14. Therefore, the first fastener 10 and the second fastener 22 are identical to each other. In the preferred embodiment, the first fastener 10 and the second fastener 22 are a ⅛-inch hanger bracket hardware. Furthermore, the positions of the plurality of fastener screw holes 11, the plurality of fastener screws 12, the slot 13 and the flange 14 are identical on both the first fastener 10 and the second fastener 22. On both of the first fastener 10 and the second fastener 22, the plurality of fastener screw holes 11 is situated laterally and vertically on each side of the first fastener 10 and the second fastener 22. The plurality of fastener screw holes 11 serves as attachment points for the plurality of fastener screws 12 to affix to the first fastener 10 and the second fastener 22. Each of the plurality of fastener screws 12 collinearly traverses through each of the plurality of fastener screw holes 11. The plurality of fastener screws 12 allows the first fastener 10 to be attached to the front bracket side 2 of the dadoed fan bracket 1, and the second fastener 22 to be attached to the back plaque side 21 of the face plaque 19. The slot 13 and the flange 14 of the first fastener 10 and the second fastener 22 are positioned adjacent to each other with the slot 13 located beneath the flange 14.

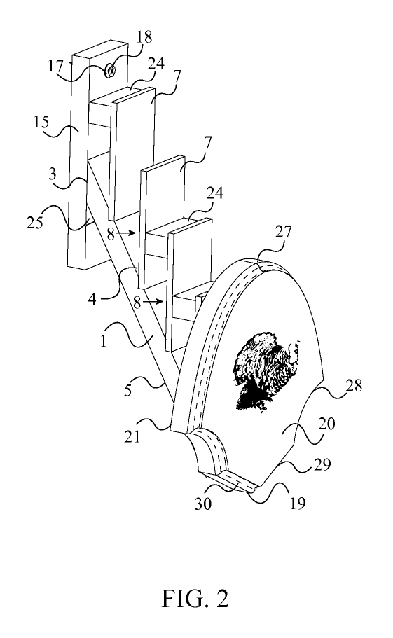

Once attached to the front bracket side 2, the first fastener 10 is positioned in an upright manner wherein the flange 14 of the first fastener 10 points upward with the slot 13 of the first fastener 10 located beneath the flange 14, on the hanger hardware block 26. The second fastener 22 is positioned horizontally centered on the back plaque side 21 and near the bottom side the face plaque 19. The flange 14 of the second fastener 22 is positioned downward and toward the bottom side of the face plaque 19. The upward protrusion of the flange 14 of the first fastener 10 serves as a receiver end of the slot 13 of the second fastener 22 located on the back plaque side 21. Therefore, the first fastener 10 is to be mated with the second fastener 22 wherein the slot 13 of the first fastener 10 receives the flange 14 of the second fastener 22, and the slot 13 of the second fastener 22 receives the flange 14 of the first fastener 10. Once the second fastener 22 is engaged to the first fastener 10, the face plaque 19 can be attached to the front bracket side 2 of the dadoed fan bracket 1. Therefore, the face plaque 19 is removable. Due to the centered position of the second fastener 22 on the back plaque side 21, the face plaque 19 is thus positioned centered onto the front bracket side 2 of the dadoed fan bracket 1 as shown in FIG. 1 and FIG. 2.

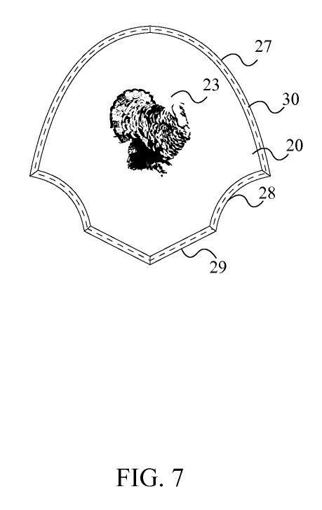

On the opposite side of the face plaque 19 is a front plaque side 20, which comprises a space for a graphic 23. The face plaque can be seen in FIG. 7. The graphic 23 may be engraved, embossed or printed centered onto the front plaque side 20. In the preferred embodiment, the graphic 23 is an engraved work of a turkey. The face plaque 19 may be composed of different wood types including but not limited to cherry, oak, and pine. In the preferred embodiment, the face plaque 19 is a symmetrical ornament comprising a semi-elliptical top portion 27, a pair of curved portions 28, and a pair of edged portions 29. The semi-elliptical top portion 27 is positioned above the pair of curved portions 28 and the pair of edged portions 29. Attached below each end of the semi-elliptical top portion is a curved portion. Therefore, the pair of curved portions 28 is positioned symmetrically below the semi-elliptical top portion 27. Moreover, the pair of curved portions 28 is positioned opposite to each other below the semi-elliptical top portion 27. Located below the pair of curved portions 28 is the pair of edged portions 29. Similarly to the pair of curved portions 28, the pair of edged portions 29 is positioned symmetrically below the pair of curved portions 28. Furthermore, the pair of edged portions 29 is positioned opposite to each other below the pair of curved portions 28. In addition to the aforementioned ornamental portions of the face plaque 19, the front plaque side 20 of the face plaque 19 comprises an elevated flat surface protruding from the face plaque 19. The elevated flat surface comprises a smaller surface area compared to the surface area of the front plaque side 20. Therefore, the elevated flat surface is offset from the front plaque side 20 by a thin margin. The thin margin is recognizable by an edge trim 30 which is contoured against the outline of the face plaque 19. Therefore, the front plaque side 20 is slightly protruded outward whereas the back plaque side 21 is planar.

The method of constructing and assembling a multi turkey fan mount is initiated by constructing and assembling a body of the multi turkey fan mount wherein the body comprises the dadoed fan bracket 1, the wall plate 15, the plurality of dividers 7, the plurality of dadoes 6, the angled support block 25, the hanger hardware block 26, the first fastener 10 and the wall plate screw hole 16. The face plaque 19 is created wherein the front plaque side 20 of the face plaque 19 comprises an engraved graphic and the back plaque side 21 of the face plaque 19 comprises the second fastener 22. Then, a plurality of foam blocks 24 is created wherein the width of each of the plurality of foam blocks 24 is equivalent to the width between each of the plurality of dividers 7. Once the plurality of foam blocks 24 is cut and created, the plurality of foam blocks 24 is stained to color. In assembling the multi turkey fan mount, the second fastener 22 on the back plaque side 21 of the face plaque 19 is attached to the first fastener 10 on the front bracket side 2 of the dadoed fan bracket 1. To facilitate the attachment of the face plaque 19 to the front bracket side 2 of the dadoed fan bracket 1, the second fastener 22 is positioned directly above the first fastener 10, and slid down to allow the second fastener 22 to engage to the first fastener 10. The method of constructing the multi turkey fan mount may be accomplished with a molding head cutter or any similar machine.

The method of constructing the body of the multi turkey fan mount is initiated by creating the wall plate 15 wherein the wall plate 15 is a rectangular block comprising a length three times longer than the width, and a thickness three times thinner than the width. The plurality of dividers 7 is created with equal dimensions wherein the plurality of dividers 7 comprises an identical width, an identical length, and an identical thickness. The dadoed fan bracket 1 is created by creating a plurality of dadoes 6 on a top bracket side 4 of the dadoed fan bracket 1, and by cutting the front bracket side 2 of the dadoed fan bracket 1 and the back bracket side 3 of the dadoed fan bracket 1 at predetermined angle. In the preferred embodiment, the plurality of dadoes 6 are 30/60 degree dado cuts. The method of applying the plurality of dadoes 6 to the top bracket side 4 of the dadoed fan bracket 1 and the method of cutting the front bracket side 2 of the dadoed fan bracket 1 and the back bracket side 3 of the dadoed fan bracket 1 at a predetermined angle may be accomplished with a molding head cutter. Next, the angled support block 25 and the hanger hardware block 26 are similarly created using the molding head cutter. In the preferred method, the angled support block 25 and the hanger hardware block 26 have been cut into triangular solids each comprising three faces. Both of the angled support block 25 and the hanger hardware block 26 comprise one side which has been cut at the same predetermined angle as the dadoed fan bracket 1. Consequently, finish is applied to the body of the multi turkey fan mount.

In assembling the body of the multi turkey fan mount, the back bracket side 3 of the dadoed fan bracket 1 is adhered to the wall plate 15 with the plurality of dadoes 6 facing upward. Then, the angled support block 25 is adhered to the bottom bracket side 5 of the dadoed fan bracket 1, adjacent to the wall plate 15. Similarly, the hanger hardware block 26 is adhered to the front bracket side 2 of the dadoed fan bracket 1 and the top bracket side 4 of the dadoed fan bracket 1. Subsequently, the plurality of dividers 7 is inserted and affixed to each of the plurality of dadoes 6. The first fastener 10 is then attached to the front bracket side 2 of the dadoed fan bracket 1, connecting the hanger hardware block 26 to the dadoed fan bracket 1. A wall plate screw hole 16 is drilled into the wall plate 15, above the plurality of dividers 7. It is desirable to drill a 3/16 inch pilot hole in a wall stud or solid paneling at least 14 inches down from the ceiling for top fan clearance. The 2-inch wood screw is applied to the wall plate screw hole 16 on the wall plate 15 and traversing through the washer 17, the wall plate screw hole 16 on the wall plate 15 and the pilot hole in the wall, securely fastening the present invention to the wall. In the preferred embodiment, a #8×2 inch wood screw is applied.

The method of creating the face plaque 19 is initiated by cutting and routing a piece of wood in a desired form. The face plaque 19 may be created by adhering more than one piece of wood together. An edge trim 30 is applied to the outline of the face plaque 19. Subsequently, a graphic 23 is imprinted centered onto the front plaque side 20 of the face plaque 19. Next, the face plaque 19 is sanded followed by an application of finish to the wood. The second fastener 22 is then attached to the back plaque side 21 of the face plaque 19 by attaching a plurality of fastener screws 12 to the second fastener 22. Then, finish is applied to the face plaque 19.

Although the invention has been explained in relation to its preferred embodiment, it is to be understood that many other possible modifications and variations can be made without departing from the spirit and scope of the invention as hereinafter claimed.

What is claimed is:

1. A multi turkey fan mount comprises:
a dadoed fan bracket;
a plurality of dadoes
a plurality of dividers;
a plurality of spaces;
a wall plate;
a face plaque;
a plurality of foam blocks;
an angled support block;
a hanger hardware block;
a first fastener;
the dadoed fan bracket comprises a front bracket side, a back bracket side, a top bracket side and a bottom bracket side;
the wall plate comprises a wall plate screw hole, a washer, and a wall plate screw;
the face plaque comprises a front plaque side, a back plaque side, a second fastener and a graphic; and
the first fastener and the second fastener each comprises a plurality of fastener screw holes, a plurality of fastener screws, a slot and a flange.

2. The multi turkey fan mount as claimed in claim 1 comprises,
the back bracket side being adhered to the wall plate at an angle;
the plurality of dadoes being situated on the top bracket side;
the plurality of dadoes being positioned equidistant from each other;
the plurality of dadoes being serially distributed along the top bracket side;
the plurality of dadoes being evenly distributed along the top bracket side;
the plurality of dividers being situated on the top bracket side;
the plurality of dividers being positioned equidistant from each other;
the plurality of dividers being serially distributed along the top bracket side;
the plurality of dividers being evenly distributed along the top bracket side;
the plurality of spaces being positioned equidistant from each other;
the plurality of spaces being serially distributed along top bracket side;
the plurality of spaces being evenly distributed along the top bracket side;
each of the plurality of dividers being positioned inside each of the plurality of dadoes;
each of the plurality of dividers being affixed to each of the plurality of dadoes;
the face plaque being attached to the front side of the dadoed fan bracket; and
the graphic being centrally positioned onto the front plaque side.

3. The multi turkey fan mount as claimed in claim 2 comprises,
the angled support block being adhered to the bottom bracket side; and
the angled support block being adhered adjacent to the wall plate.

4. The multi turkey fan mount as claimed in claim 2 comprises,
the hanger hardware block being adhered to the top bracket side;
the hanger hardware block being adhered to the front bracket side; and
the hanger hardware block being attached to the back plaque side.

5. The multi turkey fan mount as claimed in claim 2 comprises,
the face plaque being attached to the front bracket side via the first fastener;
the face plaque being attached to the front bracket side via the second fastener; and
the back of plaque being attached to the front bracket side.

6. The multi turkey fan mount as claimed in claim 3 comprises,
the plurality of fastener screw holes being positioned laterally on the first fastener;
the plurality of fastener screw holes being positioned laterally on the second fastener; and
the plurality of fastener screws traversing through the plurality of screw holes.

7. The multi turkey fan mount as claimed in claim 3 comprises,
the slot being centrally positioned on the first fastener; and
the slot being centrally positioned on the second fastener.

8. The multi turkey fan mount as claimed in claim 3 comprises,
the flange being centrally positioned on the first fastener;
the flange being centrally positioned on the second fastener; and
the flange being positioned atop the slot.

9. The multi turkey fan mount as claimed in claim 2 comprises,
the plurality of foam blocks being situated in the plurality of spaces.

10. The multi turkey fan mount as claimed in claim 2 comprises,
the wall plate screw hole being centrally positioned on the wall plate;
the wall plate screw hole being situated above the plurality of dividers;
the wall plate screw being attached to the wall plate;
the washer being attached to the wall plate; and
the wall plate screw collinearly traversing through the washer and the wall plate screw hole.

11. A method of constructing a multi turkey fan mount comprises the steps of:
a) assembling a body of the multi turkey fan mount, wherein the body comprises a dadoed fan bracket, a wall plate, a plurality of dividers, a plurality of dadoes, an angled support block, a hanger hardware block, a first fastener and a hole;
b) constructing a face plaque, wherein the face plaque comprises a graphic and a second fastener;
c) constructing a plurality of foam blocks, wherein a width of each of the plurality of foam blocks is equivalent to a width between each of the plurality of dividers; and
d) assembling the multi turkey fan mount by attaching the second fastener on the face plaque to the first fastener on a front side of the body.

12. The method of constructing the multi turkey fan mount as claimed in claim 11, wherein step (a) includes the steps of:
a) constructing the wall plate by creating a rectangular block;
b) constructing the plurality of dividers;
c) constructing the dadoed fan bracket by creating the plurality of dadoes on a top side of the dadoed fan bracket, and cutting a front side of the dadoed fan bracket and a back side of the dadoed fan bracket at a predetermined angle;
d) constructing the angled support block and the hanger hardware block, wherein one side of both of the angled support block and the hanger hardware block has been cut at the same predetermined angle as the dadoed fan bracket;
e) adhering the back side of the dadoed fan bracket to a front side of the wall plate with the plurality of dadoes facing upward;
f) affixing each of the plurality of dividers to each of the plurality of dadoes;
g) adhering the angled support block to a bottom side of the dadoed fan bracket, adjacent to the wall plate;
h) adhering the hanger hardware block to the front side of the dadoed fan bracket and the top side of the dadoed fan bracket;
i) attaching the first fastener to the front side of the dadoed fan bracket connecting the hanger hardware block to the dadoed fan bracket; and
j) drilling the hole into the wall plate, above the plurality of dividers.

13. The method of constructing the multi turkey fan mount as claimed in claim 11, wherein step (b) includes the steps of:
a) constructing the face plaque in a desired form through cutting and routing;
b) applying an edge trim to an outline of the face plaque;
c) imprinting the graphic centered on the front plaque side of the face plaque;
d) sanding and applying finish to the face plaque; and
e) attaching the second fastener to the back plaque side of the face plaque by applying a plurality of screws to the second fastener.

14. The method of constructing the multi turkey fan mount as claimed in claim 11, wherein a molding head cutter may be used to create the dadoed fan bracket, the wall plate, the plurality of dividers, the plurality of dadoes, the angled support block, a hanger hardware block, the face plaque, and the plurality of foam blocks.

15. The method of constructing the multi turkey fan mount as claimed in claim 11, wherein the plurality of dadoes are 30/60 degree dado cuts.

16. A multi turkey fan mount comprises:
a dadoed fan bracket;
a plurality of dadoes
a plurality of dividers;
a plurality of spaces;
a wall plate;
a face plaque;
a plurality of foam blocks;
an angled support block;
a hanger hardware block;
a first fastener;
the dadoed fan bracket comprises a front bracket side, a back bracket side, a top bracket side and a bottom bracket side;
the wall plate comprises a wall plate screw hole, a washer, and a wall plate screw;
the face plaque comprises a front plaque side, a back plaque side, a second fastener and a graphic; and
the first fastener and the second fastener each comprises a plurality of fastener screw holes, a plurality of fastener screws, a slot and a flange.

17. The multi turkey fan mount as claimed in claim 16 comprises,
the back bracket side being adhered to the wall plate at an angle;
the plurality of dadoes being situated on the top bracket side;
the plurality of dadoes being positioned equidistant from each other;
the plurality of dadoes being serially distributed along the top bracket side;
the plurality of dadoes being evenly distributed along the top bracket side;
the plurality of dividers being situated on the top bracket side;
the plurality of dividers being positioned equidistant from each other;
the plurality of dividers being serially distributed along the top bracket side;
the plurality of dividers being evenly distributed along the top bracket side;
the plurality of spaces being positioned equidistant from each other;
the plurality of spaces being serially distributed along top bracket side;
the plurality of spaces being evenly distributed along the top bracket side;
each of the plurality of dividers being positioned inside each of the plurality of dadoes;
each of the plurality of dividers being affixed to each of the plurality of dadoes;
the face plaque being attached to the front side of the dadoed fan bracket; and
the graphic being centrally positioned onto the front plaque side.

18. The multi turkey fan mount as claimed in claim 17 comprises,
the angled support block being adhered to the bottom bracket side;
the angled support block being adhered adjacent to the wall plate;
the hanger hardware block being adhered to the top bracket side;
the hanger hardware block being adhered to the front bracket side;
the hanger hardware block being attached to the back plaque side;
the face plaque being attached to the front bracket side via the first fastener;
the face plaque being attached to the front bracket side via the second fastener; and
the back of plaque being attached to the front bracket side.

19. The multi turkey fan mount as claimed in claim 18 comprises,
the plurality of fastener screw holes being positioned laterally on the first fastener;
the plurality of fastener screw holes being positioned laterally on the second fastener;
the plurality of fastener screws traversing through the plurality of screw holes;
the slot being centrally positioned on the first fastener;
the slot being centrally positioned on the second fastener;
the flange being centrally positioned on the first fastener;
the flange being centrally positioned on the second fastener; and
the flange being positioned atop the slot.

20. The multi turkey fan mount as claimed in claim 17 comprises,
the plurality of foam blocks being situated in the plurality of spaces;
the wall plate screw hole being centrally positioned on the wall plate;
the wall plate screw hole being situated above the plurality of dividers;
the wall plate screw being attached to the wall plate;
the washer being attached to the wall plate; and
the wall plate screw collinearly traversing through the washer and the wall plate screw hole.
